(19) United States
(12) Patent Application Publication
(10) Pub. No.: US 2007/0091603 A1
(43) Pub. Date: Apr. 26, 2007

(54) String array lighting mount

(76) Inventor: Russell D. Taylor, (US)

Correspondence Address: Invention Perfection, LLC;443 Clark Place, American Seating Park, 801 Broadway NW, Grand Rapids, MI, 49504, US

(21) Appl. No.: 11/513,684

(22) Filed: Aug. 30, 2006

Related U.S. Application Data
(60) Provisional application No. 60/712,306, filed on Aug. 30, 2005.

(51) Int. Cl. F21V 21/00

(52) U.S. Cl. 362/249

(57) ABSTRACT

String array lighting is mounted with an elongated assembly that comprises a light shade that at least partially blocks light emission from the lighting. A series of at least translucent light emitting lenses, a plurality of hangers, and a plurality of lighting supports are disposed along the body length. The elongated assembly may define an open sided channel with first and second channel legs and a series of cross ties that are spaced along the body length and that extend across the open side from the first channel leg toward the second channel leg.

### CROSS-REFERENCE TO RELATED APPLICATIONS

This is a continuing non-provisional application of co-pending U.S. provisional Patent Application Ser. No. 60/712,306, entitled Ropelite Runners and filed on Aug. 30, 2005, by Russell D. Taylor, now expired, the disclosure of which is incorporated here by reference.

### BACKGROUND OF THE INVENTION

The invention relates to mountings for lighting and more specifically to a mounting system adapted to mount a string array of lighting.

Most people are familiar with various attempts to arrange and mount various configurations of string array lighting, which are commonly and customarily displayed in connection with Christmas and winter solstice celebration displays and the like. The string array lighting is, thus, commonly known as Christmas lights. A more recent development in string array lighting includes a rope configuration, including encasing so called Christmas lights in a clear tubular hose or rope, and various ensuing developments thereof.

Regardless of the string array lighting configuration, typical mounting attempts include: simply laying the light strings upon a structure without attachment; tying the lighting with string, wire ties, and the like; stapling the lighting to a supporting structure; and using screw hooks and the like to secure the lighting n place. Other attempts at mounting string array lighting include construction of specific substructures along the nature of forming holes in lengths of wood strips or plastic conduits with the holes adapted for placement of individual lamps of the lighting string in the holes. The string array lighting is thus or otherwise mounted to the substructure and the substructure is positioned and secured as desired. People seldom pursue the relatively great effort of building such substructures, however.

Regardless, the difficulties or challenges of mounting string array lighting are commonly and well known. Thus, a need for convenient and effective string array lighting mounting is readily understood.

### BRIEF SUMMARY OF THE INVENTION

Accordingly, a string array lighting mount of the invention is adapted to conveniently and effectively arrange and secure string array lighting. The mount may commonly have an elongated body with a light shade that at least partially blocks light emission from the string array lighting and a series of at least translucent light emitting lenses. The lenses, a plurality of hangers, and a plurality of lighting supports are disposed along the body length. The supports are adapted to support string array lighting.

In various aspects of the invention, the body may be generally tubular and may further define an open sided channel with a first channel leg and a second channel leg. The elongated body may include an elongated wall with at least one lens defined by an aperture through the wall. At least a portion of the wall may define the shade. A flange may extend from the body and defines a hanger and may extend along the body and defines the plurality of hangers.

In other aspects of the invention, the elongated body may include a series of cross ties extending across the open side of the open sided channel. The cross ties may be spaced along the length of the body. The cross tie may define a hanger or may define at least a portion of the shade. A lens may be defined between a first one of the ties and a second one of the ties. At least one of the cross ties may have an end that releasably couples with the second channel leg. Further, at least one of the cross ties may have a first end that releasably couples with the first channel leg and a second end that releasably couples with the second channel leg.

These and other features, objectives, and benefits of the invention will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is an upper, left end perspective view of a first embodiment of string array lighting mount of the invention, shown upon a generally vertical surface, such as a length of deck;

FIG. 2 is an upper, left end perspective view of a modular length thereof with an elongated body;

FIG. 3 is the view of FIG. 2 in partial fragment, showing a plurality of lighting supports that are spaced along the body length;

FIG. 4 is a front elevation view thereof;

FIG. 5 is a front elevation view thereof in partial fragment, showing the plurality of lighting supports spaced along the body length;

FIG. 6 is a lower right fragmentary perspective view of two modular lengths thereof; showing the two lengths spaced near one another in an uncoupled condition;

FIG. 7 is the view of FIG. 6, showing the two lengths in a coupled condition;

FIG. 8 is an enlarged detail of a right end of a modular length thereof, showing a self flange thereof;

FIG. 9 is an upper perspective view of an outside corner connector with two modular lengths thereof;

FIG. 10 is an upper perspective view of the outside corner connector;

FIG. 11 is an upper perspective view of the outside corner connector in partial fragmentary view, showing a plurality of lighting supports;

FIG. 12 is an upper perspective view of an inside corner connector with two modular lengths thereof;

FIG. 13 is an upper perspective view of the inside corner connector;

FIG. 14 is an upper perspective view of the inside corner connector in partial fragmentary view, showing a plurality of lighting supports; and

FIG. 15 is a right end perspective view of a modular length thereof, showing the plurality of lighting supports that are spaced along the body length and showing an optional additional shade cover;

FIG. 16 is a left end perspective view of a second embodiment of string array lighting mount of the invention, shown upon a generally vertical surface, such as a length of deck or railing, showing a length of string array lighting supported thereby; FIG. 17 is an upper, left end perspective view in partial fragment, of a modular length thereof with an elongated body, showing a plurality of lighting supports spaced along the body length; and

FIG. 18 is an upper, left end perspective view of two modular lengths thereof;

FIG. 19 is an exploded view of an upper and right end perspective of a third embodiment of string array lighting mount of the invention, showing a length of string array lighting supported thereby;

FIG. 20 is an upper and right end perspective view thereof, shown upon a generally vertical surface, such as a length of deck or railing;

FIG. 21 is a fragmentary upper and right end perspective view thereof, showing mounting positioning of hangers thereof;

FIG. 22 is an upper and right perspective view of a hanger thereof;

FIG. 23 is a right side elevation of the third embodiment of string array lighting mount assembly;

FIG. 24 is a right end schematic view thereof, showing a partially assembled condition relative to a generally vertical surface, showing a length of string array lighting supported thereby; and

FIG. 25 is the view of FIG. 24 in a final installed condition;

FIG. 26 is an exploded view of an upper and right end perspective of a fourth embodiment of string array lighting mount of the invention, showing a length of string array lighting supported thereby;

FIG. 27 is a right end schematic view thereof, showing a first partially assembled condition relative to a generally vertical surface;

FIG. 28 is the view of FIG. 27 in a second partially installed condition;

FIG. 29 is the view of FIG. 27 in a third partially installed condition;

FIG. 30 is the view of FIG. 27 in a final installed condition;

FIG. 31 is front right perspective view of the fourth embodiment of string array lighting mount of the invention in the second partially installed condition of FIG. 28, shown upon a generally vertical surface, such as a length of deck or railing;

FIG. 32 is an upper right end perspective schematic view thereof, showing mounting positioning of a base plate thereof;

FIG. 33 is the view of FIG. 32, showing hanger ties positioned upon the base plate thereof;

FIG. 34 is the view of FIG. 33, showing a channel portion thereof positioned relative to the hanger ties and the base plate thereof;

FIG. 35 is an upper right end perspective view of the fourth embodiment of string array lighting mount assembly, showing a length of string array lighting supported thereby;

FIG. 36 is an upper and right perspective view of a hanger thereof, and

FIG. 37 is a right side elevation of the fourth embodiment of string array lighting mount assembly;

FIG. 38 is an upper perspective view of a fifth embodiment of string array lighting mount of the invention in a landscape perimeter installation, showing a portion of the string array lighting mount in exploded view;

FIG. 39 is an enlarged detail of the exploded portion thereof;

FIG. 40 is a cross section view thereof, showing use of the fifth embodiment of string array lighting mount in combination with a known landscape edging and the like;

FIG. 41 is a fragmentary perspective view thereof, showing placement along a surface of a walk or a deck and the like;

FIG. 42 is a cross section view thereof, showing the lighting mount optionally oriented with its lenses directing light toward the surface as opposed to the shade portion directing light away from the surface;

FIG. 43 is a front elevation view of a modular length of the fifth embodiment of string array lighting mount;

FIG. 44 is a left end perspective view thereof;

FIG. 45 is a fragmentary front elevation of two abutting lengths thereof;

FIG. 46 is an end perspective view of a coupler thereof; and

FIG. 47 is the view of FIG. 45, showing the coupler installed;

FIG. 48 is fragmentary left front perspective view of a sixth embodiment of string array lighting mount; and

FIG. 49 is the view of FIG. 48, showing installation with landscape stakes.

### DETAILED DESCRIPTION

Several preferred and merely exemplary embodiments of a string array lighting mount according to the invention are generally shown in the drawing figures and discussed below. Common to each embodiment are foundational elements of the inventive string array lighting mount, including a body 102 with shade 104, lens 106, hanger 108, and support 110 structure portions. These reference numerals shall be used across the several variations of the invention discussed below.

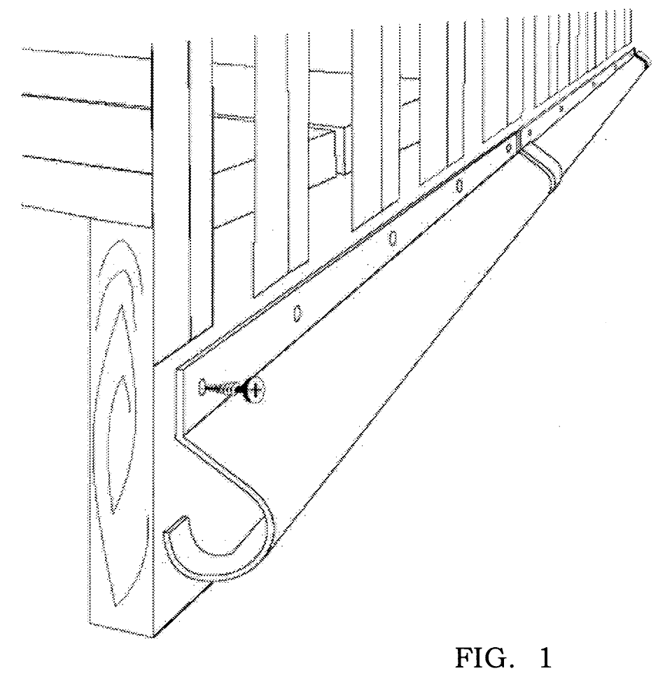

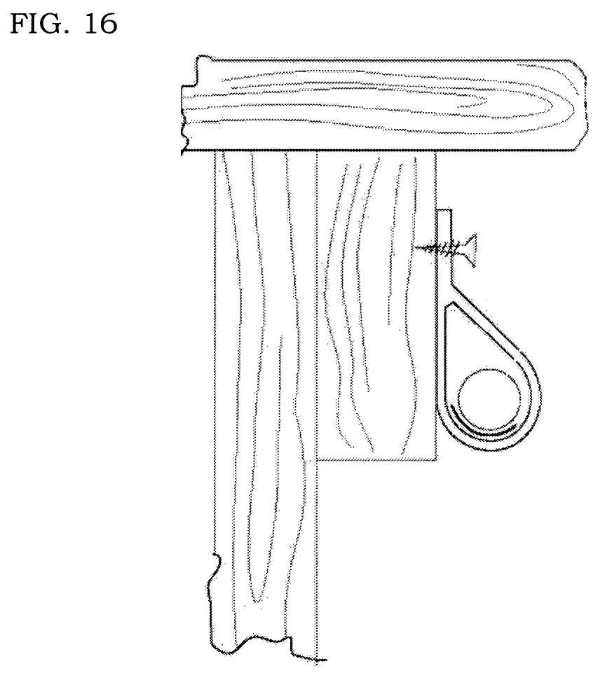

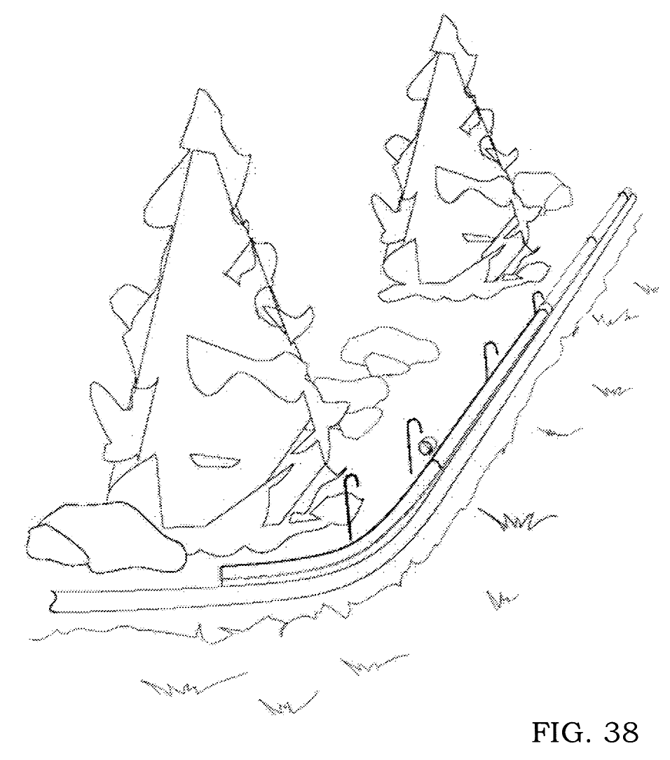

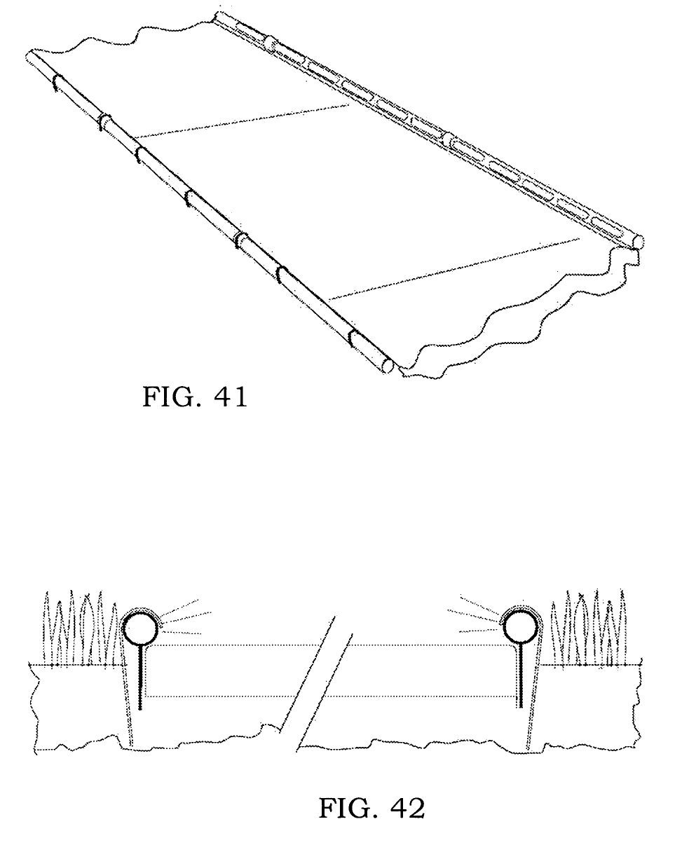

A string array lighting mount according to the invention may be useful in various lighting environments, including exterior installations like decks, landscaping, pools, and pathways, and interior installations. The unique design of the invention provides for directing and casting of string array lighting as desired for a particular installation, depending upon various embodiment factors, including width, length, and orientation of the lenses 106. Some sample installation settings may include: placement about a perimeter of a deck to cast light down onto landscape areas (FIG. 1); placement under a railing cap to cast light onto spindles and walk or deck surfaces (FIGS. 16 and 20); placement along landscape area edgings (FIG. 38); placement along walking paths (FIG. 41); placement on a wall near a ceiling to cast light onto the ceiling; and placement on a wall spaced from a floor to illuminate an entertainment area. Many additional indoor and outdoor installations of string array lighting with a mount according to the invention will occur to one having ordinary skill in the art and to those who use the invention.

Further, the several preferred embodiments of a string array lighting mount according to the invention and additional variations, as will occur to one having ordinary skill in the art from the teaching of this invention, may be constructed of any suitable material, including plastics, metals, woods, their combinations, and their variations. Any fabrication process may also be used as may be appropriate for the material selected.

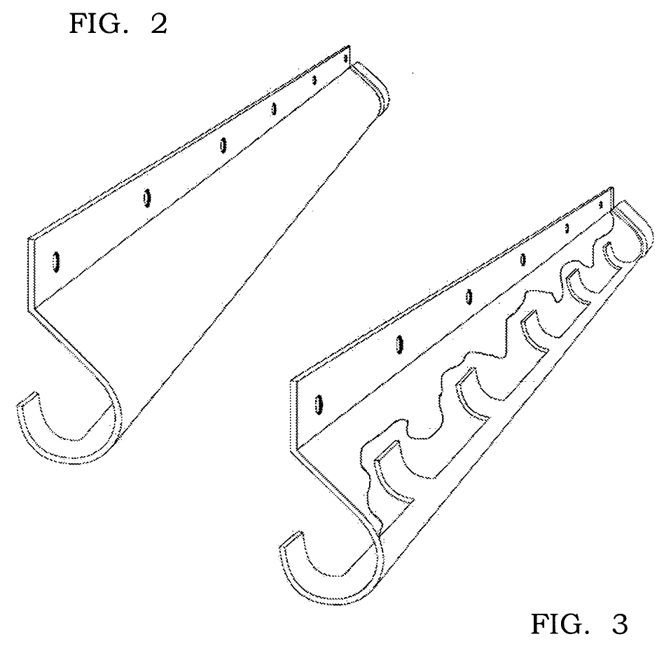

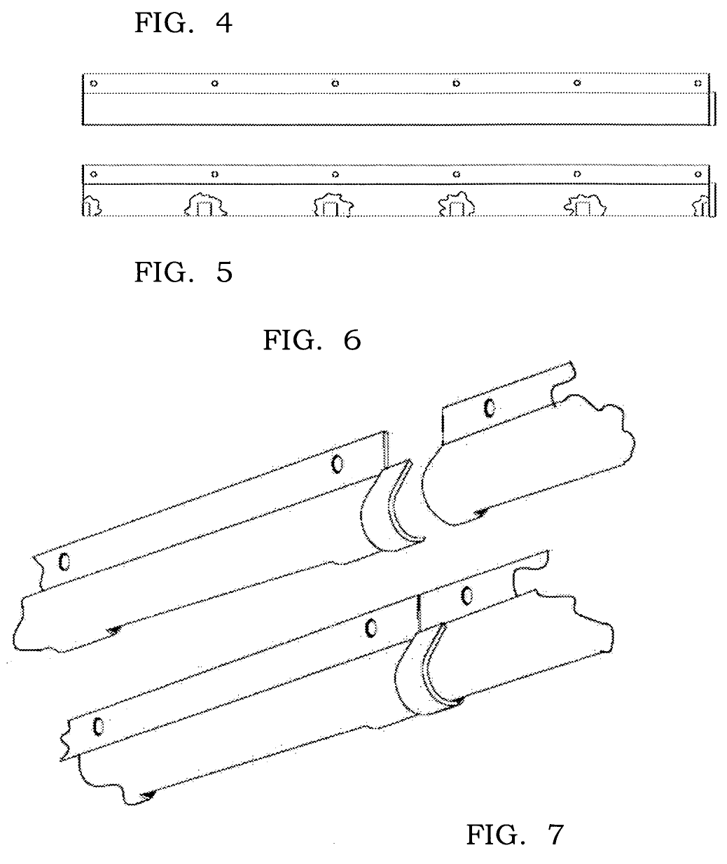

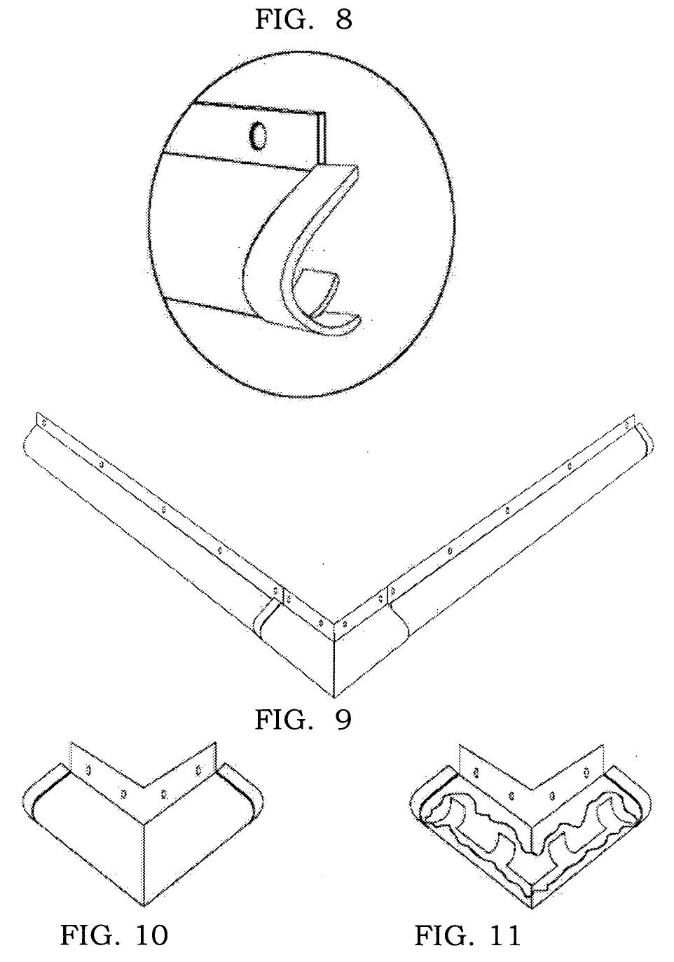

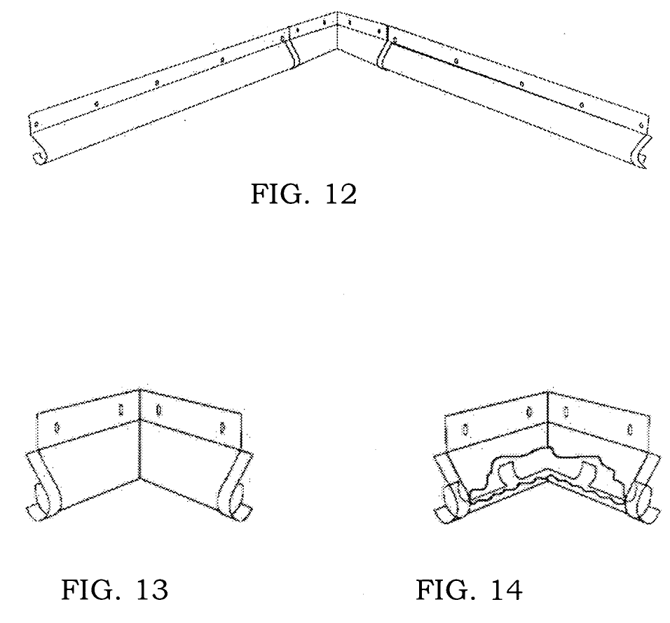

A first preferred embodiment 200 of a string array lighting mount 100 according to the invention is generally shown in the drawing FIGS. 1-15 in which common elements including a body 102 with shade 104, lens 106, hanger 108, and support 110 structure portions are identified. While the deck perimeter installation noted above is specifically shown in FIG. 1, this is not a limitation of the invention, which may be installed upon any suitable foundational structure, either vertical or horizontal and either indoor or outdoor.

In the first embodiment 200, the invention is shown configured in modular length sections 201 of a generally tubular or open-sided channel geometry. The hanger 108 is formed as a flange that extends generally radially outward from and lengthwise along an elongated body. A series of fastening holes may be provided in the flange to accommodate commonly known screw or nail fastening and the like of each length of modular section of the embodiment 200 to a supporting structure.

The support is defined by way of a series of fingers 202 that extend from a first leg 204 and across an open side toward a second leg 206. This leaves a gap as shown between the first and the second legs, so that string array lighting may be easily laid into the mount and upon the support fingers 202.

Adjacent lengths of modular sections of the embodiment 200 may be conveniently coupled by provision of a self-coupling 212 on one end of the sections as is commonly known in closed tubular plastic electrical conduit and the like. More specifically, each modular length has an uniform end profile at a first end 214. The self-coupling 212 has an interior configuration that corresponds to the uniform end profile at a first end. The self-coupling is also formed on an opposite second end of each modular length. Thus, adjacent modular sections may merely “plug” together, so a first end of an adjacent second modular section may slide into and mate with the self-coupler of an adjacent first modular section (FIGS. 6-8).

To facilitate assembling several lengths of modular sections of the embodiment 200 around various structures, angle fittings may be provided and may include exterior corner fittings 222 and interior corner 224 fittings (FIGS. 9-14), among others as desired. Each fitting provided may include the features of the modular lengths 201, including the hanger 108, the support 110 with fingers 202, and the self-coupling 212 structure portions.

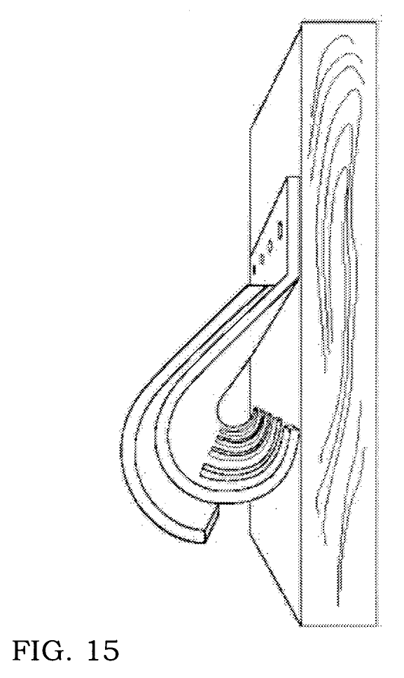

An additional decorative shade 250 may desirably be added (FIG. 15).

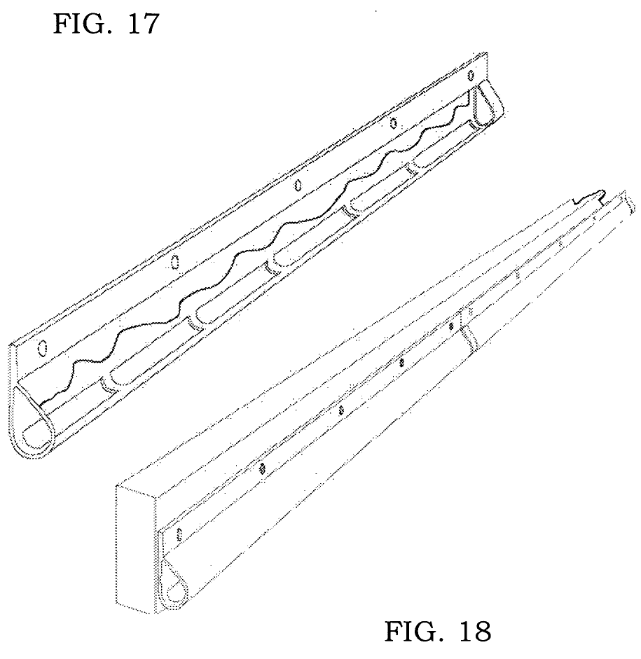

A second preferred embodiment 300 of a string array lighting mount according to the invention is generally shown in the drawing FIGS. 16-18 in which common elements including a body 102 with shade 104, lens 106, hanger 108, and support 110 structure portions are identified. The embodiment 300 is similar to the embodiment 200 and differs significantly in that the fingers 302 of embodiment 300 extend from a first leg of an open sided channel body and across an open side toward a second leg, and further extend farther to actually extend between and connect with each leg.

As with the embodiment 200, the embodiment 300 may also incorporate a self-coupling 312 on one end of each section, so adjacent lengths of modular sections may be conveniently coupled. Also, various angle fittings may be provided to facilitate assembling several lengths of modular sections around various structures, including exterior corner fittings and interior corner 224, among others as desired.

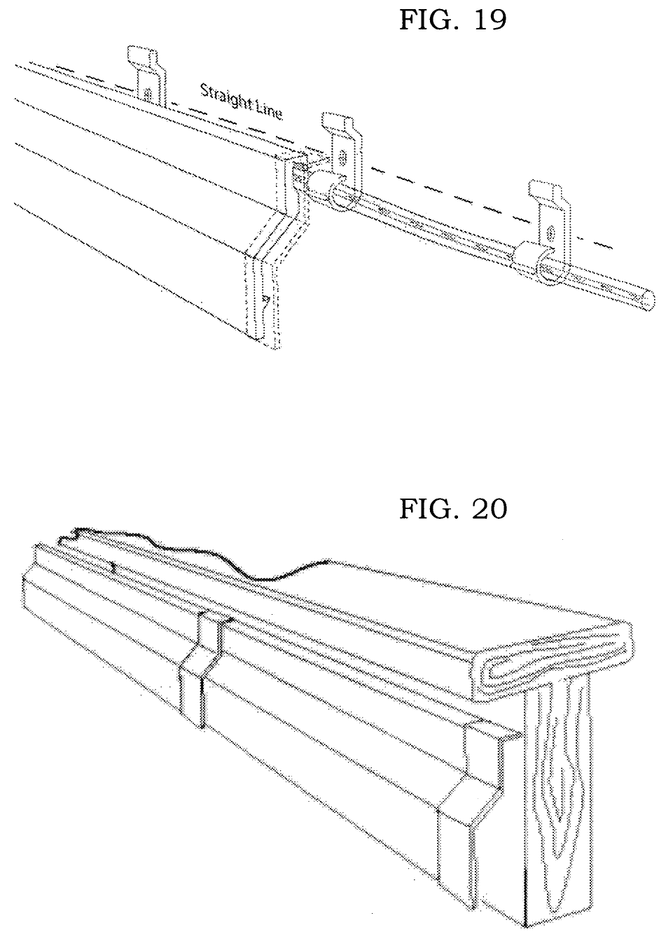

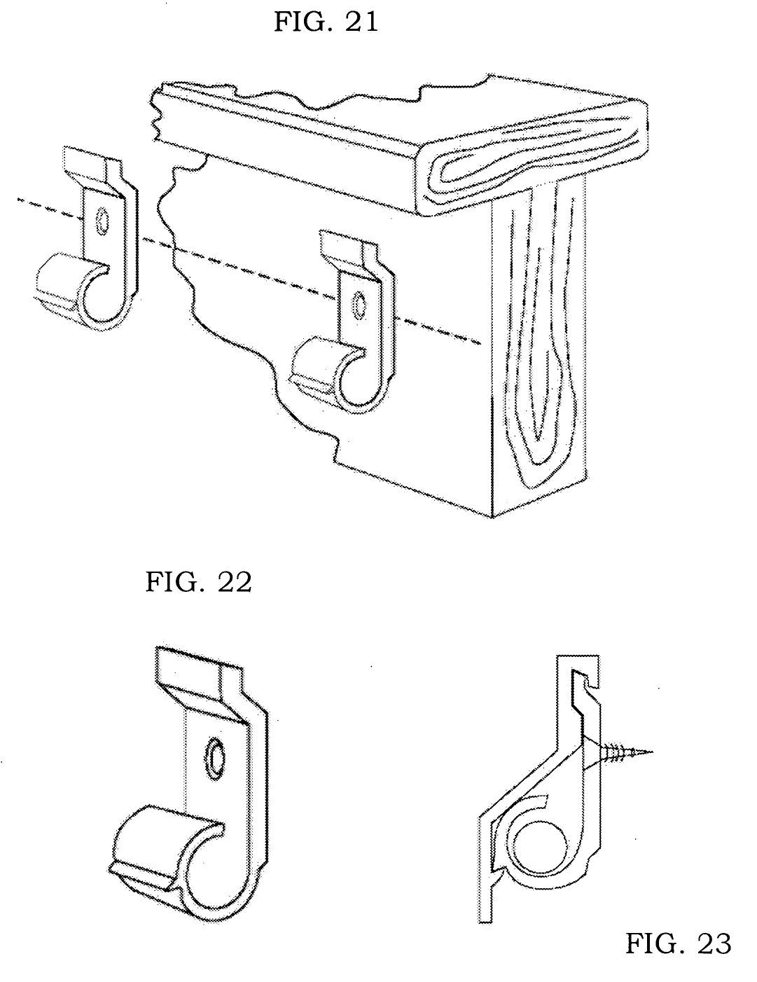

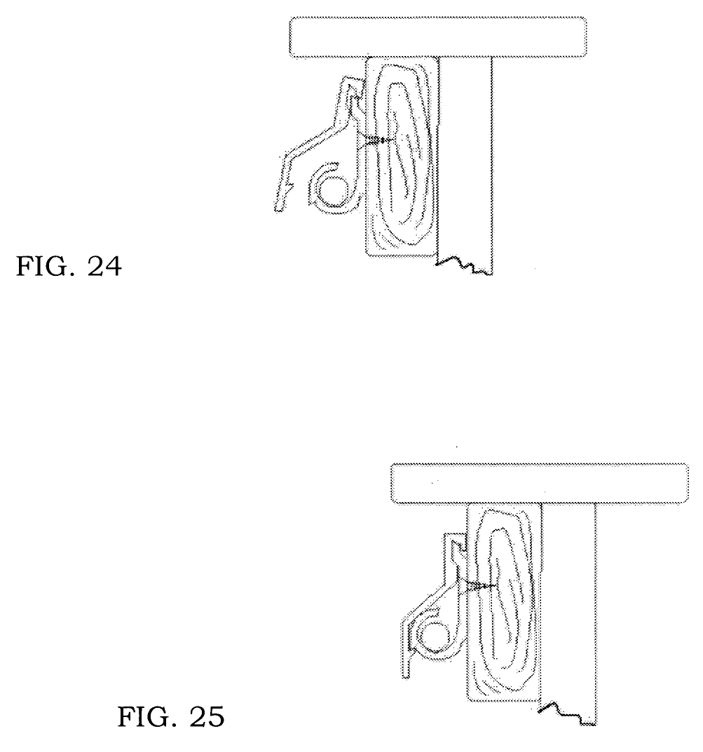

A third preferred embodiment 400 of a string array lighting mount according to the invention is generally shown in the drawing FIGS. 19-25 in which common elements including a body 102 with shade 104, lens 106, hanger 108, and support 110 structure portions are identified. The embodiment 400 is also similar to the embodiment 200 and differs significantly in that the fingers of embodiment 300 may be separate members that define hangers 108 and incorporate supports 110.

The hangers 108 are generally J-shaped members that have a short leg 402 and a long leg 404 extending in the same general direction from a bight portion that defines the support 110 (FIG. 22). The long leg terminates at a shade hanger upper edge 406 and includes at least one fastening hole 408 to accommodate commonly known screw or nail fastening and the like as discussed above. The short leg curls upward from the bight portion 110 and is spaced from the long leg so that string array lighting may be easily laid into the hanger and upon the support with the short leg substantially capturing and cradling the lighting in a preselected location. A shade latch 412 may be formed on the short leg in the form of a barb flange or recess or the like.

The body 102 in embodiment 400 is formed as an open-sided channel with a first leg 422 and a second leg 424 (FIG. 23). A portion of the body, including portions of each of the legs 422 and 424, define the shade 104. A flange 414 is provided at a terminal end of the first leg 422 and cooperates with the top edge 406 to hang the body or shade on the hanger 108. The flange may further be configured as a groove as shown, into which the hanger edge 406 is seated. A flange is provided on the second leg 424 to define a shade catch 416 that cooperates with the shade latch 412.

In use, a series of hangers 108 may be secured to a supporting structure by screw fastening, adhesive fastening, or other desired method, for example, and are preferably disposed along a straight line. A desired string lighting 60 is placed between the hanger legs 402 and 404 to rest on the support 110. A length of the string array lighting mount body 102 is secured to at least a portion of the series of hangers by mating the flange 414 with respective ones of the hanger top edges 406 and slightly pivoting the body downward to engage the shade latch 412 with the shade catch 416, and snap fasten the respective hangers with the body.

Whence so assembled, the body 104, more specifically the shade portion 104 of the body, the supporting structure, and the hangers 108, perhaps more specifically the support 110 portion of the hangers, define an open space or lens 1.06 there between, through which light from the lighting 60 is cast and by which the light is directed.

Each length of the body 104 in this embodiment 400 may preferably be provided with a self-coupling 412 in the manner discussed above relative to the prior embodiments. Thus, adjacent modular sections may merely “plug” together, so a first end of an adjacent second modular section may slide into and mate with the self-coupler of an adjacent first modular section.

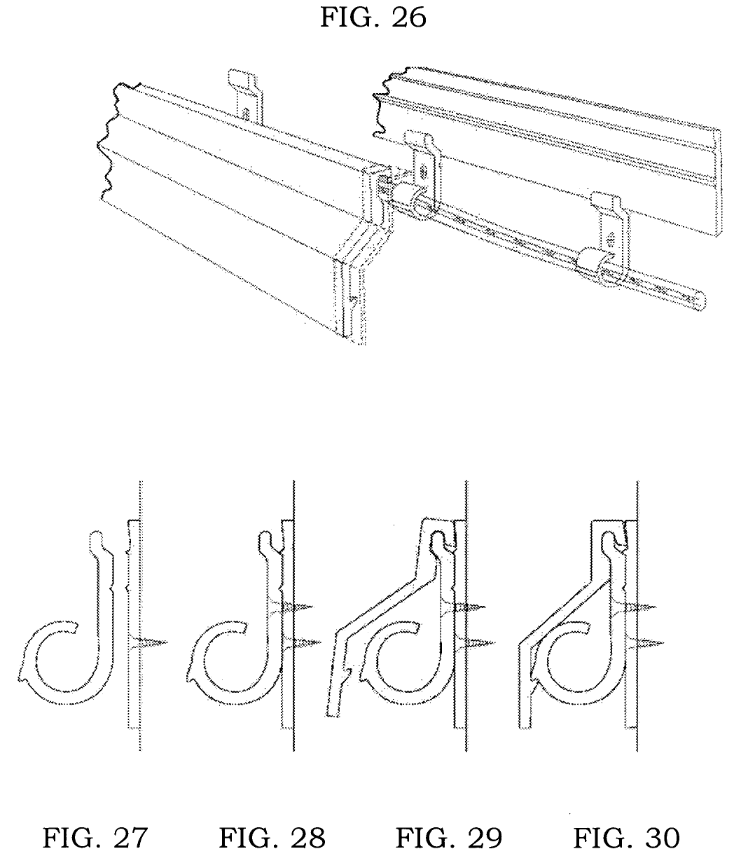

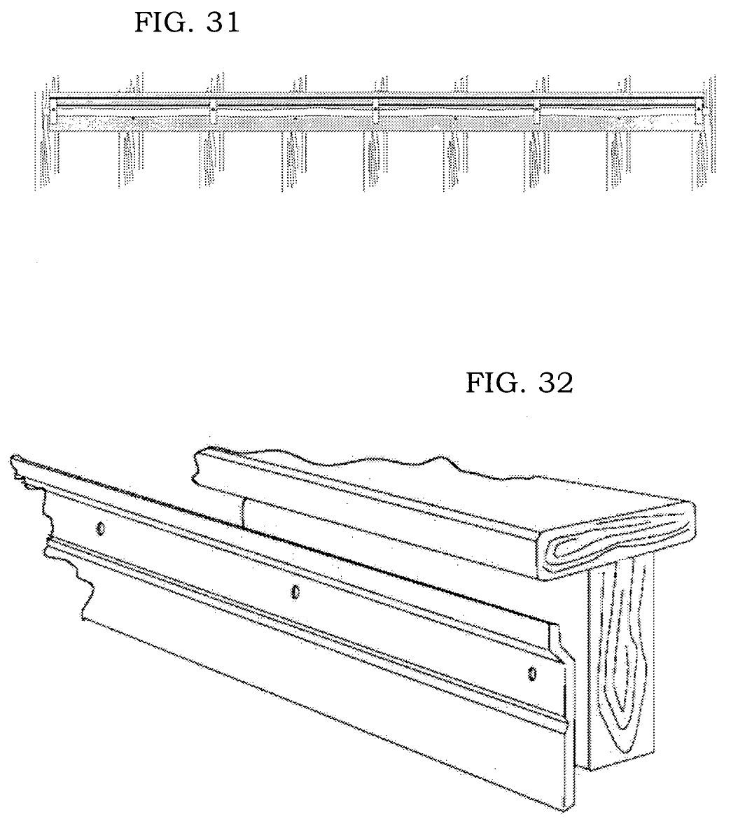

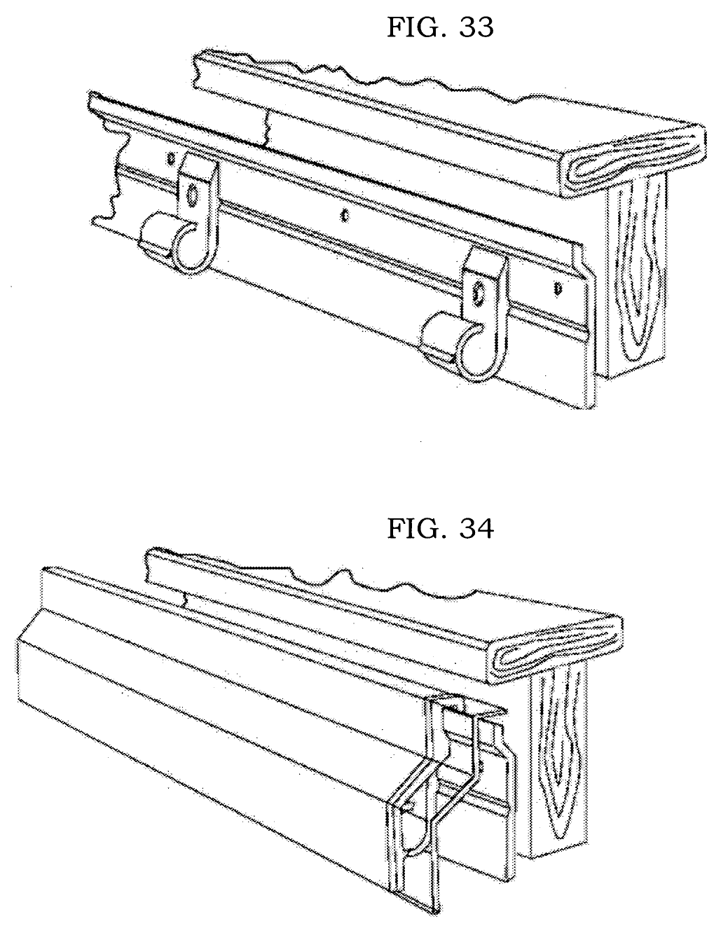

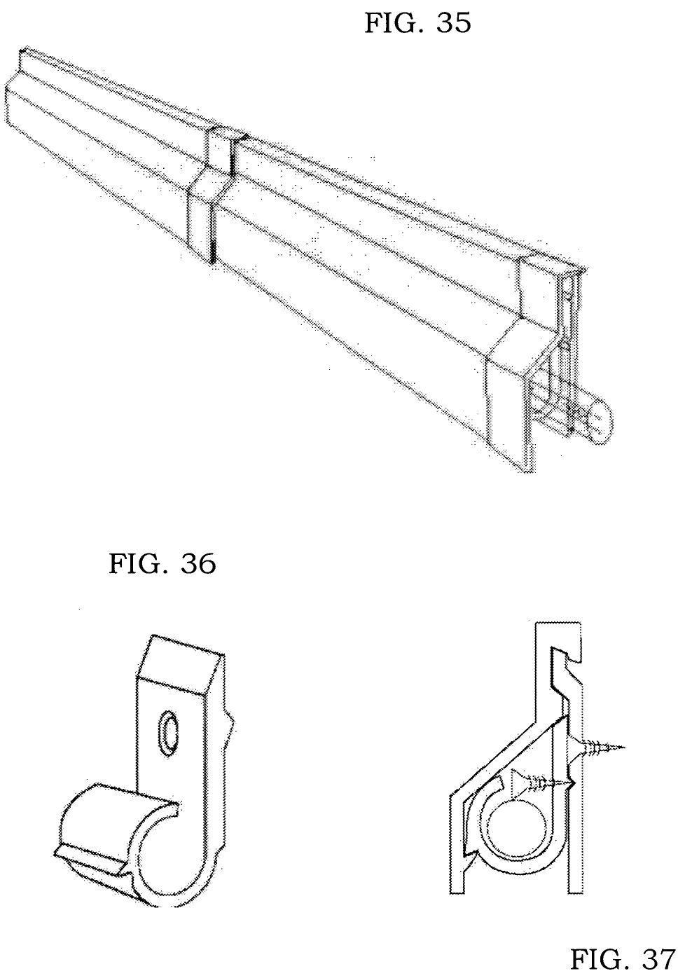

A fourth preferred embodiment 500 of a string array lighting mount according to the invention is generally shown in the drawing FIGS. 26-37 in which common elements including a body 102 with shade 104, lens 106, hanger 108, and support 110 structure portions are identified. The embodiment 500 is substantially similar to the embodiment 400 and differs significantly by addition of a quick mount backing plate 550 that may also define at least a portion of the shade.

The plate 550 is an elongated member that may be generally configured as a rectangular solid as shown. A series of mounting holes 552 that are adapted for screw or nail fastening, for example, may preferably be provided along a length of the plate. A hanger alignment device, which is shown as a groove 554, may preferably be defined along the plate as is discussed further below. A shade hanger flange 556 may also preferably be provided along a top edge of the plate.

The hangers 108 are generally J-shaped members that have a short leg 502 and a long leg 504 extending in the same general direction from a bight portion that defines the support 110 (FIG. 36). The long leg includes at least one fastening hole 508 to accommodate commonly known screw or nail fastening and the like as discussed above and in the summary. An alignment barb 506 that correspond to and is adapted to cooperate with the alignment device 554 may be provided along the long leg 504.

The short leg 502 of the hangers 108 curls upward from the bight portion 110 and is spaced from the long leg 504 so that string array lighting may be easily laid into the hanger and upon the support 110 with the short leg substantially capturing and cradling the lighting in a preselected location. A shade latch 512 may be formed on the short leg in the form of a barb flange or recess or the like.

The body 102 in embodiment 500 is formed as an open-sided channel with a first leg 522 and a second leg 524 (FIG. 23). A portion of the body, including portions of each of the legs 522 and 524, define the shade 104. A flange 514 is provided at a terminal end of the first leg 522 and cooperates with the shade hanger flange 556 of the mount backing plate 550. The flange may further be configured as a groove as shown, into which the hanger flange 556 is seated. A flange is provided on the second leg 524 to define a shade catch 516 that cooperates with the shade latch 512 of the hanger short leg 502.

In use, the mount backing plate 550 may be secured to a supporting structure by screw fastening, adhesive fastening, or other desired method, for example. A series of hangers 108 may be selectively disposed along the plate 550 with the alignment barb 506 cooperatingly engaging the hanger alignment device groove 554. Each hanger may be secured in its place upon the plate 550 by screw fastening, adhesive fastening, or other desired method, for example.

A desired string lighting 60 is placed between the hanger legs 502 and 504 to rest on the support 110. A length of the string array lighting mount body 102 is secured to at least a portion of the series of hangers by mating the flange 514 with the shade hanger flange 556 along a top edge of the plate 550, slightly pivoting the body downward to engage the shade latch 512 with the shade catch 516, and snap fasten the respective hangers with the body.

Each length of the body 104 in this embodiment 500 may preferably be provided with a self-coupling 512 in the manner discussed above relative to the prior embodiments. Thus, adjacent modular sections may merely “plug” together, so a first end of an adjacent second modular section may slide into and mate with the self-coupler of the adjacent first modular section.

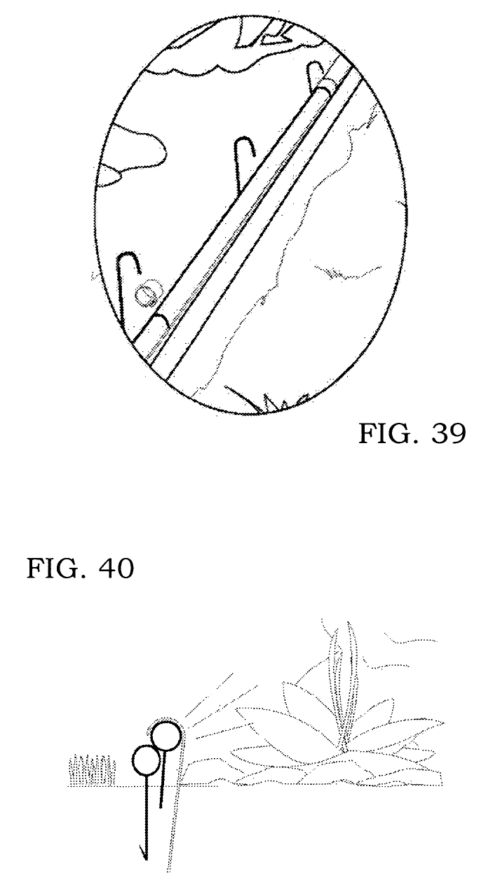

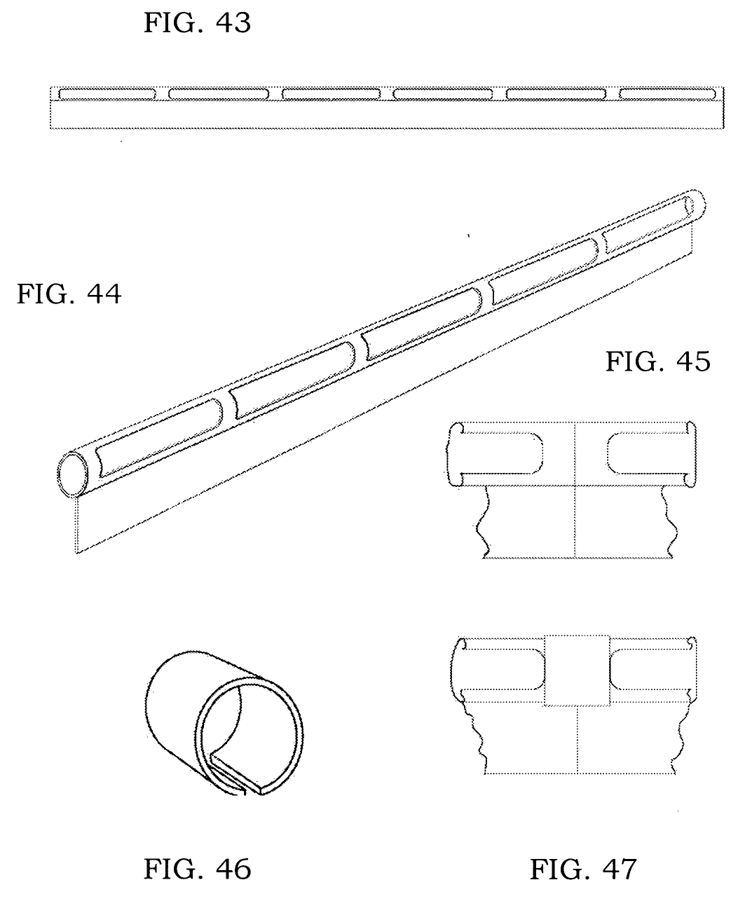

While the above discussed embodiments of a string array lighting mount of the invention are conspicuously useful in both indoor and outdoor environments where a supporting or foundational structure may be available, a fifth preferred embodiment 600 of a string array lighting mount according to the invention that lends itself to more freeform placement is generally shown in the drawing FIGS. 38-47 in which common elements including a body 102 with shade 104, lens 106, hanger 108, and support 110 structure portions are identified. The embodiment 600 is similar to the embodiment 300. While the second embodiment 300 is configured to accommodate a hanging orientation, the fifth embodiment is configured to accommodate a standing orientation.

As shown, the hanger is defined as a flange that extends along the length of body and extends generally radially out from the body. A plurality of lenses are formed along the body to preferably generally cast light other than toward the hanger.

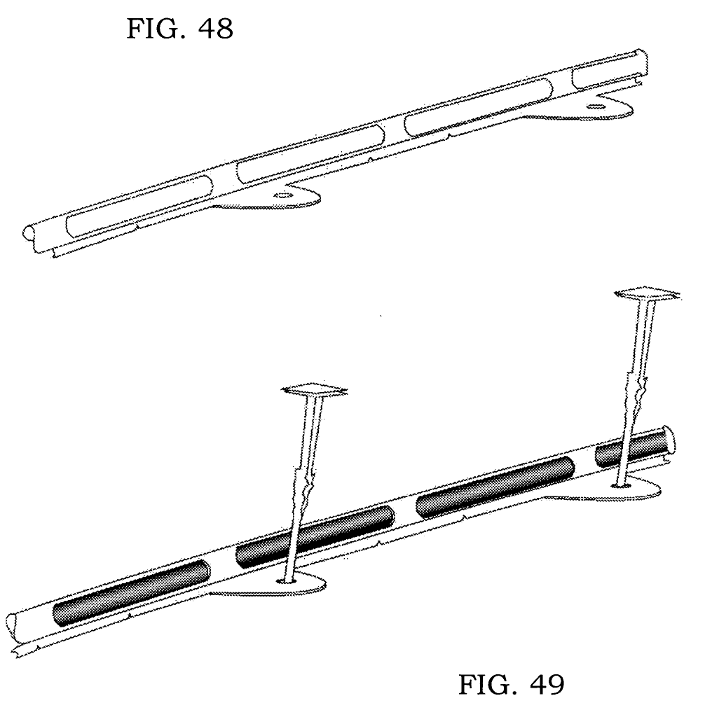

A sixth preferred embodiment 700 of a string array lighting mount according to the invention is generally shown in the drawing FIGS. 48 and 49 in which common elements including a body 102 with shade 104, lens 106, hanger 108, and support 110 structure portions are identified. The embodiment 700 is similar to each of the second embodiment 300 and the fifth embodiment 600 and is principally differentiated insofar as it is configured to generally lay upon a surface. Thus, the hanger may be defined as a series of tabs that extend generally radially outward from the body and are disposed along the length of the body. A plurality of lenses are formed along the body to cast light generally toward or away from the hanger.

One having ordinary skill in the art and those who practice the invention will understand from this disclosure that various modifications and improvements may be made without departing from the spirit of the disclosed inventive concept. One will also understand that various relational terms, including left, right, front, back, top, and bottom, for example, are used in the detailed description of the invention and in the claims only to convey relative positioning of various elements of the claimed invention.

What is claimed is:

1. A mounting that is adapted to arrange and secure string array lighting, the mounting being an elongated assembly of various component bodies, each of which body comprising a light shade that at least partially blocks light emission from the string array lighting, a series of at least translucent light emitting lenses that are disposed along the body, a plurality of hangers that are spaced along the body length, and a plurality of lighting supports that are spaced along the body length and adapted to support string array lighting.

2. The mounting defined in claim 1 wherein the body is generally tubular.

3. The mounting defined in claim 2 wherein the elongated assembly includes an elongated wall and at least one lens is defined by an aperture through the wall.

4. The mounting defined in claim 3 wherein at least a portion of the wall defines the shade.

5. The mounting defined in claim 4 wherein a flange extends from the body and defines a hanger.

6. The mounting defined in claim 4 wherein a flange extends along the body and defines the plurality of hangers.

7. The mounting defined in claim 1 wherein the elongated assembly includes an elongated wall and at least one lens is defined by an aperture through the wall.

8. The mounting defined in claim 7 wherein at least a portion of the wall defines the shade.

9. The mounting defined in claim 1 wherein a flange extends from the body and defines a hanger.

10. The mounting defined in claim 1 wherein a flange extends along the body and defines the plurality of hangers.

11. The mounting defined in claim 1 wherein the elongated assembly generally defines an open sided channel with a first channel leg and a second channel leg and wherein the elongated assembly includes a series of cross ties extending across the open side, the cross ties being spaced along the length of the elongated assembly.

12. The mounting defined in claim 11 wherein at least one of the cross ties has an end that releasably couples with a respective one of the first and the second channel legs.

13. The mounting defined in claim 12 wherein the at least one cross tie defines a hanger.

14. The mounting defined in claim 11 wherein at least one of the cross ties has a first end that releasably couples with the first channel leg and has a second end that releasably couples with the second channel leg

15. The mounting defined in claim 14 wherein the at least one cross tie defines a hanger.

16. The mounting defined in claim 11 wherein at least one of the cross ties defines a hanger.

17. The mounting defined in claim 11 wherein at least one of the cross ties defines at least a portion of the shade.

18. The mounting defined in claim 11 wherein at least one of the lenses is defined between a first one of the ties and a second one of the ties.

19. A mounting that is adapted to arrange and secure string array lighting, the mounting being an elongated assembly of various component bodies, each of which body comprising a body that defines an open sided channel with a first channel leg and a second channel leg with a series of cross ties extending across the open side from the first channel leg toward the second channel leg and being spaced along the length of the elongated assembly, the first channel leg defining at least a portion of a light shade that at least partially blocks light emission from the string array lighting, a series of at least translucent light emitting lenses being disposed along the body, a plurality of hangers that are spaced along the body length, and a plurality of lighting supports that are spaced along the body length and adapted to support string array lighting.
